(19) United States
(12) Patent Application Publication
(10) Pub. No.: US 2025/0013946 A1
(43) Pub. Date: Jan. 9, 2025

(54) System and method for managing and optimizing order scheduling

(71) Applicant: SYNAOS GMBH, Hannover (DE)

(72) Inventors: Lennart Bochmann, Hannover (DE); Gregor Franke, Velpke (DE); Tobias Gagern, Wolfsburg (DE); Wolfgang Hackenberg, Oberpfaffenhofen (DE); Mayur Hole, Berlin (DE); Dennis Romanowsky, Braunschweig (DE)

(21) Appl. No.: 18/712,338

(22) PCT Filed: Nov. 22, 2022
(86) PCT No.: PCT/EP2022/082693

§ 371 Date: May 22, 2024

(30) Foreign Application Priority Data
Nov. 22, 2022 (EP) 21209693.7

(51) Int. Cl. G06Q 10/0631; G06Q 10/087

(52) U.S. Cl. CPC G06Q 10/0631; G06Q 10/087

(57) ABSTRACT

A system and method with a controlling component, which can be configured for monitoring mobile components. The controlling component adjusts the scheduling of a plurality of mobile components at the same time in case of detecting at least one pre-defined event. The plurality of mobile components can be all components monitored or a subgroup thereof. The controlling component is configured for monitoring mobile components with a frequency of monitoring of at least one time a minute (1/min.) and for adjusting the scheduling of a plurality of mobile components in case of detecting at least one pre-defined event. It can alternatively or additionally also be configured for monitoring mobile components and for adjusting the scheduling of a plurality of mobile components with a frequency of adjusting of at least one time a minute (1/min.).

### FIELD

The present invention relates to a system and a method for managing and optimizing order scheduling, such as for logistics vehicles in a manufacturing/production plant.

### INTRODUCTION

For a long time, it is attempted to control order scheduling, e.g. in the automotive industry, in particular the scheduling of vehicles in a manufacturing plant. Such order scheduling in a manufacturing environment is particularly challenging as any unexpected incident has a cascade of implications and particularly delays and/or other negative effects on a material flow. Thus, an optimized scheduling with respect to timing, reliability, manufacturing, product flows etc. is of utmost importance.

U.S. Pat. No. 7,756,631 B2 relates to an absolutely optimal scheduling or a quasi-optimal scheduling is computed for a first plurality of resources m to be routed to a second plurality of resource destinations n, depending on a count of m and n. Three different algorithms are used. For the case where the count is m≤6 and n≤8, a first algorithm is used to arrive at an absolutely optimal scheduling. An example of the first algorithm is Depth First Branch and Bound Search. For a second count, where the value of the count is more numerous than the first count, m is greater than six, but equal to, or less than or equal to fifty, 6<m≤50, and n is greater than 8, but less than or equal to one hundred, 8<n≤100, a second algorithm, is used to compute a quasi-optimal scheduling. An example of this second algorithm is Local Search. For a third count, where the count exceeds those above, a third algorithm is used for computing a quasi-optimal scheduling. Typically, this third algorithm applies where m>50, and n>100. An example of this third algorithm is swarming.

US20130159206 A1 is directed to the determining a scheduling of vehicles for pickup and delivery in a supply chain network, in one aspect, may include generating a plurality of candidate set of routes for vehicles for pickup and delivery to meet demand at multiple target locations. Unsatisfied demand at said multiple target locations resulting from completing pickup and delivery according to the generated plurality of candidate set of routes may be determined. A set of vehicles routes are selected from said plurality of candidate set of routes that minimizes said unsatisfied demand across all said multiple target locations by applying an optimization function.

US20130138330 A1 describes a system and method to optimize mass transport vehicle scheduling based on additional ton-mile cost information in one embodiment, a starting location and a plurality of customer locations associated with a warehouse and a plurality of customers, respectively, are identified. Furthermore, a plurality of pairs of locations is identified using the starting location and plurality of customer locations. Mileage cost information and ton-mile cost information are then dynamically computed for each of the plurality of pairs of locations. In addition, sets of mass transport vehicle routes between the starting location and plurality of customer locations are dynamically determined using the pairs of locations and a number of vehicles to be used. Moreover, trip cost information is computed, in real-time, for each set of mass transport vehicle routes. Also, an optimized set of mass transport vehicle routes is determined, in real-time, using the trip cost information.

U.S. Pat. No. 8,706,409 B2 relates to a vehicle management systems and associated processes can consider energy consumption when selecting routes for fleet vehicles. Vehicle management systems and associated processes are described that, in certain embodiments, evaluate vehicle energy usage based on factors such as terrain or elevation, vehicle characteristics, driver characteristics, road conditions, traffic, speed limits, stop time, turn information, traffic information, and weather information, and the like. The features described herein may also be implemented for non-fleet vehicles, such as in personal vehicle navigation systems.

US20180268371 A1 considers a vehicle scheduling problem with pickup and delivery, time windows, and location resource constraints. Locations provide a number of cumulative resources that are utilized by vehicles either during service (e.g., forklifts) or for the entirety of their visit (e.g., parking bays). The problem is highly challenging from a computational standpoint as the resource constraints add temporal dependencies between vehicles and a scheduling substructure not featured in traditional vehicle scheduling problems. The main contribution of this disclosure is a branch-and-price-and-check model that incorporates a branch-and-price algorithm that solves the underlying vehicle scheduling problem, and a constraint programming subproblem that checks the feasibility of the location resource constraints, and then adds combinatorial no-good cuts to the master problem if the resource constraints are violated.

US20180129985 A1 relates to a computer-implemented method, computerized apparatus and computer program product for selecting time windows to vehicle scheduling problems. A set of criteria for estimating desirability of scheduling an appointment to a time interval, and a set of time intervals at which appointments can be scheduled are obtained. A new appointment for scheduling to a time interval is received. For each time interval of the set, a balanced score according to the set of criteria is calculated. A time interval for scheduling the new appointment is selected based on the balanced score.

US20210081894 A1 is directed to a method of performing constrained vehicle scheduling includes representing variables in an embedded space. The variables are clustered such that cluster elements are compatible with one another. A constrained vehicle scheduling problem is solved at a level of the clusters. The constrained vehicle scheduling solution at the level of the clusters is expanded to a level of the variables. Each tour of the constrained vehicle scheduling solution expanded to the level of the variables is separately refined.

US20190101401 A1 describes a transportation management service that can utilize an objective function to balance various metrics when selecting scheduling options to serve a set of customer trip requests. The objective function can provide a compromise between rider experience and provider economics, taking into account metrics such as rider convenience, operational efficiency, and ability to deliver on confirmed trips. The analysis can consider not only planned trips, or trips currently being planned, but also trips currently in progress. One or more optimization processes can be applied, which can vary the component values or weightings of the objective function, in order to attempt to improve the quality score generated for each proposed scheduling solution. A solution can be selected for implementation based at least in part upon the resulting quality scores of the proposed scheduling solutions.

DE 102014006699 A1 relates to a method for assigning components of an industrial plant to a navigation tree, method for parameterization and or commissioning of components of an industrial plant, assignment device and parameterization and or commissioning device wherein in a mapping device, it is proposed to create a plant model computer-aided for an industrial plant, wherein further components are represented by structural elements. Nodes assigned to those are arranged in a navigation tree, each computer-tested whether the assignment structurally fits to control and/or output elements for the components in the navigation tree.

### SUMMARY

In light of the above, it is an object of the present invention to overcome or at least alleviate the shortcomings of the prior art. More particularly, it is an object of the present invention to provide a method and a corresponding system for controlling, optimizing and/or managing order scheduling, particularly in a manufacturing plant.

The term system can comprise an integrated component or a plurality of aggregated, assembled and/or connected components. All or some of the components can be located locally and/or remotely.

The method corresponds to the system in so far that the method steps correspond to the features of the system described and specified herein below. In general, the following description of the system also applies to the method in terms of method features and vice versa.

The present invention particularly relates to a system and a method for controlling, planning, optimizing and/or managing intralogistics. Wherever a feature is described with respect to the system a corresponding method feature is also comprised in the method category, and vice-versa.

The term intralogistics is intended to comprise material transport processes inter alia in factories or warehouse sites, particularly by mobile components. It can also comprise infrastructure, such as paths, ways, roads, wired and/or wireless communication systems, handhelds for operators or users, gates, traffic lights, barriers, doors, nodes, induction loops, production material supply, loading stations, unloading stations, battery chargers, batteries etc.

Order scheduling is the process of assigning orders to a fleet of mobile components such as transport units. The transport orders can be described by a pick-up location and a drop-off location, goods to be handle and/or a latest possible delivery time. Order scheduling can influence all parameters having an impact onto the scheduling of orders. Non-limiting examples are the choice of mobile components available, their status, the location and/or time of loading, routing etc.

The present system and method for controlling intralogistics can comprise a controlling component wherein the controlling component is configured for monitoring mobile components and/or infrastructure and for adjusting a scheduling of a plurality of mobile components and/or infrastructure at the same time in case of detecting at least one pre-defined event.

The controlling component can be alternatively or additionally be configured for monitoring mobile components and/or infrastructure with a frequency of monitoring of at least one time a minute (1/min.) and for adjusting a scheduling of a plurality of mobile components and/or infrastructure in case of detecting at least one pre-defined event.

Additionally or alternatively, the controlling component can be configured for monitoring mobile components and/or infrastructure and for adjusting a scheduling of a plurality of mobile components and/or infrastructure with a frequency of adjusting of at least one time a minute (1/min.).

The controlling component can be an integral component or can comprise an optimizing component for optimizing the intralogistics and a managing component for communicating with the mobile components and/or the infrastructure.

The system and method can provide a planning/optimizing component. This can be provided by a single component or a plurality of sub-components. The controlling component can be configured for monitoring mobile components.

The optimizing component is intended to comprise an integral or non-integral component that can be configured to plan and/or organize order scheduling.

The managing component can be configured to receive the state of the mobile components and/or the infrastructure, at least in part. It can be further configured to communicate the state of the mobile components and/or the infrastructure, at least in part, to the optimizing component.

The managing component is intended to comprise an integrated (such as into a controlling component also integrating the optimizing component or into the controlling component) or a non-integral component that can communicate with mobile components, infrastructure etc. to be controlled or managed.

The system and method can provide a controlling/monitoring component. This can be provided by a single component or a plurality of sub-components. The controlling component can be configured for monitoring mobile components.

Mobile components are intended to comprise anything that can transport and/or handle goods, such as transport units. Transport units can be vehicles, mobile robots, humans or better handheld devices for users and/or drones. In some instances, also containers that are moved can be understood to be comprised. They can comprise one kind of components or—in most cases—different kinds of components.

Infrastructure or infrastructure assets are intended to comprise any kind of infrastructure used for the order scheduling, such as paths, induction loops, wired or wireless communication, traffic lights, gates, doors, conveyors etc.

The controlling component can be also provided and/or configured for adjusting the commands of a/the plurality of transport units at the same time in case of detecting at least one pre-defined event. The plurality of transport units can be all components monitored or a subgroup thereof, such as at least 10, at least 20, at least 50, at least 100, at least 500 or at least 1000 or even more. This is intended to show that the present invention is able to control and schedule a large number or complex assembly of mobile components, infrastructure etc. simultaneously

Scheduling is intended to mean a basic time-management comprising a list of times at which possible tasks, events, or actions, particularly of transport units, are intended to take place, or of a sequence of events in the chronological order in which such things are intended to take place. The process of creating a schedule—deciding how to order these tasks and how to commit resources between the variety of possible tasks—is called scheduling. The output of the scheduling is also designated as a schedule. It can also comprise a routing of transport units or re-routing, that is that they take a different route for realizing a schedule.

This can provide the advantage that by the controlling, monitoring and/or managing all components, such as the infrastructure, the other components can be relieved, such as the mobile components.

Additionally or alternatively, the controlling component can be also configured for monitoring mobile components with a frequency of monitoring of at least one time a second (1/sec.) and for adjusting the scheduling of a plurality of mobile components in case of detecting at least one pre-defined event and/or also any unexpected event.

It can alternatively or additionally also be configured for monitoring mobile components and for adjusting the scheduling of a plurality of mobile components with a frequency of adjusting of at least one time a minute (1/min.).

The invention can be configured for controlling vehicles and/or infrastructure in a plant, such as a manufacturing plant.

The system and method can be configured to receive schedule information of each of a plurality of mobile components and/or infrastructure with a frequency of at least one time a minute (1/min.). Particularly, the system and method can be configured to receive schedule information of each of a plurality of mobile components (20) with a frequency of at least once each 60 seconds (1/60 s), preferably at least once each 30 seconds (1/30 s), more preferably at least once each 10 seconds (1/10 s), more preferably at least twice a second (2/s), and most preferably once a second (1/s).

There can be also arranged different priorities for controlling components or infrastructure. Battery status can thus be of less priority and thus frequency than the position of a mobile component.

The controlling and particularly the optimizer component can further comprise a computing component that is configured to compute an adjusting of the scheduling of a plurality of mobile components and/or infrastructure. The controlling and/or optimizing component can further comprise a computing component that is configured to compute an adjusting of the scheduling of a plurality of mobile components by computing a plurality of optional schedules and selecting one.

The controlling and/or optimizing component can further comprise a computing component that is configured to compute an adjusting of the scheduling of a plurality of mobile components by computing a plurality of optional schedules and selecting the best and or most efficient one with respect to different criteria (e.g., the shortest time possible for the schedule, or the schedule that is producing the fewest delays, or the schedule that is using the fewest mobile components)

The controlling and/or optimizing component can further comprise a remote computing component that is configured to compute an adjusting of the scheduling of a plurality of mobile components by computing a plurality of optional schedules and selecting one.

The controlling and/or optimizing component can further comprise a cloud-based computing component that is configured to compute an adjusting of the scheduling of a plurality of mobile components by a computing of a plurality of optional schedules and selecting one,

The controlling and/or optimizing component can further comprise a computing component that is configured to compute an adjusting of the scheduling of a plurality of mobile components by computing a plurality of optional schedules and selecting one and providing the selected schedule for the adjusting of the scheduling or the plurality of mobile components.

The frequency of controlling and/or optimizing the intralogistics can amount to a frequency of at least once each 60 seconds (1/60 s), preferably at least once each 30 seconds (1/30 s), more preferably at least once each 10 seconds (1/10 s), more preferably at least twice a second (2/s), and most preferably once a second (1/s). This is understood to relate to the actual adjustment or re-adjustment of each intralogistics component by the system. Any frequency delivered by the intralogistics component can be higher, though.

The controlling and/or optimizing component can further comprise a computing component that is configured to compute an adjusting of the scheduling of a plurality of mobile components by computing a plurality of optional schedules in parallel and selecting one. There can be at least 100, preferably at least 1,000, more preferably at least 100,000 and even more than 1 million computations in 1 second. The computation frequency can just be higher than the actual controlling and/or optimizing frequency to the intralogistics components.

The frequency of receiving status data (such as information and/or feed-back) from the intralogistics can amount to at least 1,000 times a minute (1,000/min.), preferably 2,500 times a minute (2,500/min.), more preferably 5,000 times a minute (5,000/min.) and most preferably at least 10,000 times a minute (10,000/min.).

The frequency of adjusting and/or managing can amount to at least 2 times a minute (2/min.), preferably 3 times a minute (3/min.), more preferably 5 times a minute (5/min.) and most preferably at least 10 times a minute (10/min.).

The frequency of adjusting and/or managing can mount to at least 1,000 times a minute (1,000/min.), preferably 2,500 times a minute (2,500/min.), more preferably 5,000 times a minute (5,000/min.) and most preferably at least 10,000 times a minute (10,000/min.).

The system and method can be configured to optimize, monitor and/or adjust a fleet with a plurality of vehicles.

The vehicles can comprise at least one of fork lifts, battery driven vehicles, transport vehicles, mobile robots, vehicles driven by humans, handhelds for guiding and/or assisting humans and/or users of any of the before-mentioned devices, etc.

The pre-defined event can comprise a delay or early arrival of a mobile component, a blockage in a route, a defect, a defect of loading station and/or battery, an early or unexpected emptied reservoir of any kind etc.

The system and method can further comprise a map (e.g., comprising nodes and/or edges), the nodes being references for locations in a plant and wherein the system is configured to detect a vehicle is in the vicinity of and/or passing a respective node.

The nodes can be virtually located in a plant at points of interest for the scheduling. The nodes can be configured to be virtually re-located. The virtual re-location of the nodes can be based on machine learning.

The pre-defined event can comprise a maintenance need of the mobile component, such as a failure of operation, a battery charge, a handling problem with material to be moved, wrong material loaded, improper operation.

The system and method can be configured for taking into account the time for loading a battery of a mobile component.

Further, the system can comprise an optimizer component that is configured for controlling the mobile components and for adjusting their scheduling.

The controlling component can comprise a manager component that can be configured for communication with the mobile components, e.g., via an interface.

The invention is further described with the following numbered embodiments.

Below, system embodiments will be discussed. These embodiments are abbreviated by the letter “S” followed by a number. Whenever reference is herein made to “system embodiments”, these embodiments are meant.
S1. System for controlling intralogistics comprising:
   a controlling component (10)
      a. wherein the controlling component is configured for monitoring mobile components (20) and/or infrastructure; and
      b. for adjusting a scheduling of a plurality of mobile components (20) and/or infrastructure at the same time in case of detecting at least one pre-defined event.
S2. System for controlling intralogistics comprising:
   a controlling component (10)
      a. wherein the controlling component is configured for monitoring mobile components (20) and/or infrastructure with a frequency of monitoring of at least one time a minute (1/min.); and
      b. for adjusting a scheduling of a plurality of mobile components (20) and/or infrastructure in case of detecting at least one pre-defined event.
S3. System for controlling intralogistics comprising:
   a controlling component (10)
      a. wherein the controlling component is configured for monitoring mobile components (20) and/or infrastructure; and
      b. for adjusting a scheduling of a plurality of mobile components (20) and/or infrastructure with a frequency of adjusting of at least one time a minute (1/min.).
S4. System combining at least two of any of the preceding system embodiments.
S5. System according to any one of the preceding system embodiments wherein the controlling component (10) comprises an optimizing component (10a) for optimizing the intralogistics and a managing component (10b) for communicating with the mobile components (20) and/or the infrastructure.
S6. System according to the preceding system embodiment wherein the managing component (10b) is configured to receive the state of the mobile components (20) and/or the infrastructure, at least in part.
S7. System according to the preceding system embodiment wherein the managing component (10b) is configured to communicate the state of the mobile components (20) and/or the infrastructure, at least in part, to the optimizing component (10a).
S8. System according to any one of the preceding system embodiments wherein the infrastructure comprises paths, ways, roads, wired and/or wireless communication systems, handhelds for operators or users, gates, traffic lights, barriers, doors, nodes, induction loops, production material supply, loading stations, unloading stations, battery chargers, and/or batteries.
S9. System according to any of the preceding system embodiments wherein the plurality of mobile components (20) and/or infrastructure comprise at least 10 mobile components, preferably at least 20 mobile components, more preferably at least 50 mobile components, more preferably at least 100 mobile components, more preferably at least 500 components, and most preferably at least 1000 mobile components.
S10. System according to any of the preceding system embodiments wherein the mobile components comprise vehicles (20).
S11. System according to any of the preceding system embodiments wherein the manager component (10b) is configured to generate one or more action command(s) to nodes (12), vehicles (20), mobile robots, manually guided vehicles, humans or better their handheld devices, drones, ships, infrastructure assets, such as routing units, doors, signals.
S12. System according to any of the preceding system embodiments wherein the system is configured for controlling vehicles (20) and/or infrastructure in a plant.
S13. System according to any of the preceding system embodiments wherein the system is configured for controlling vehicles (20) and/or infrastructure in a manufacturing plant.
S14. System according to any of the preceding system embodiments wherein the system is configured to receive schedule information of each of a plurality of mobile components (20) and/or infrastructure with a frequency of at least one time a minute (1/min.).
S15. System according to any of the preceding system embodiments wherein the system is configured to receive schedule information of each of a plurality of mobile components (20) and/or infrastructure with a frequency of at least once each 60 seconds (1/60 s), preferably at least once each 30 seconds (1/30 s), more preferably at least once each 10 seconds (1/10 s), more preferably at least twice a second (2/s), and most preferably once a second (1/s).
S16. System according to any of the preceding system embodiments, the controlling component (10) further comprising a computing component that is configured to compute an adjusting of the scheduling of a plurality of mobile components.
S17. System according to any of the preceding system embodiments, the controlling component (10) further comprising a computing component that is configured to compute an adjusting of the scheduling of a plurality of mobile components by computing a plurality of optional schedules and selecting one.
S18. System according to any of the preceding system embodiments, the controlling component (10) further comprising a computing component that is configured to compute an adjusting of the scheduling of a plurality of mobile components by computing a plurality of optional schedules and selecting the fastest one.
S19. System according to the preceding system embodiment further comprising a computing component that is configured to compute an adjusting of the scheduling of a plurality of mobile components by computing a plurality of optional schedules in parallel and selecting one.
S20. System according to any of the two preceding system embodiments further comprising a computing component that is configured to compute an adjusting of scheduling of at least 100, preferably at least 1,000, more preferably at least 100,000 and even more than 1 million computations in 1 second. with at least 100, preferably at least 1,000, more preferably at least 100,000 and even more than 1 million computations of optional schedules in 1 second.
S21. System according to any of the preceding system embodiments, the controlling component (10) further comprising a computing component that is configured to compute an adjusting of the scheduling of a plurality of mobile components by computing a plurality of optional schedules in parallel and selecting one.
S22. System according to any of the preceding system embodiments, the controlling component (10) further comprising a remote computing component that is configured to compute an adjusting of the scheduling of a plurality of mobile components by computing a plurality of optional schedules and selecting one.
S23. System according to any of the preceding system embodiments, the controlling component (10) further comprising a cloud-based computing component that is configured to compute an adjusting of the scheduling of a plurality of mobile components by a computing of a plurality of optional schedules and selecting one.
S24. System according to any of the preceding system embodiments, the controlling component (10) further comprising a computing component that is configured to compute an adjusting of the scheduling of a plurality of mobile components by computing a plurality of optional schedules and selecting one and providing the selected schedule for the adjusting of the scheduling or the plurality of mobile components (20).
S25. System according to any of the preceding system embodiments wherein the frequency of optimizing the intralogistics amounts to at least once each 60 seconds (1/60 s), preferably at least once each 30 seconds (1/30 s), more preferably at least once each 10 seconds (1/10 s), more preferably at least twice a second (2/s), and most preferably once a second (1/s).
S26. System according to any of the preceding system embodiments wherein frequency of receiving status data of the intralogistics amounts to at least 1,000 times a minute (1,000/min.), preferably 2,500 times a minute (2,500/min.), more preferably 5,000 times a minute (5,000/min.) and most preferably at least 10,000 times a minute (10,000/min.).
S27. System according to any of the preceding system embodiments wherein frequency of managing amount to at least once each 60 seconds (1/60 s), preferably at least once each 30 seconds (1/30 s), more preferably at least once each 10 seconds (1/10 s), more preferably at least twice a second (2/s), and most preferably once a second (1/s).
S28. System according to any of the preceding system embodiments wherein the frequency of adjusting the mobile components (20) and/or the infrastructure amounts to at least 1,000 times a minute (1,000/min.), preferably 2,500 times a minute (2,500/min.), more preferably 5,000 times a minute (5,000/min.) and most preferably at least 10,000 times a minute (10,000/min.).
S29. System according to any of the preceding embodiments wherein the system is configured to monitor and adjust a fleet with a plurality of vehicles.
S30. System according to any of the preceding system embodiments wherein the vehicles comprise at least one of fork lifts, battery driven vehicles, transport vehicles, mobile robots, vehicles driven by humans.
S31. System according to any of the preceding system embodiments wherein the pre-defined event comprises a delay or early arrival of a mobile component (20).
S32. System according to the preceding system embodiment wherein the system further comprises nodes (12) that are references for locations in a plant and wherein the system is configured to detect in case a vehicle is in the vicinity of and/or passing a respective node (12).
S33. System according to the preceding system embodiment wherein the nodes (12) are virtually located in a plant at points of interest for the scheduling.
S34. System according to any of the preceding system embodiments wherein the pre-defined event comprises a maintenance need of the mobile component (20).
S35. System according to any of the preceding system embodiments wherein the pre-defined event comprises a maintenance need of the mobile component (20), such as a failure of operation, a battery charge, a handling problem with material to be moved, wrong material loaded, improper operation.
S36. System according to any of the preceding system embodiments wherein the system is configured for taking into account the time for loading a battery of a mobile component (20).
S37. System according to any one of the preceding system embodiments wherein the controlling component (10) comprises an optimizer component (10a) that is configured for controlling the mobile components (20) and for adjusting their scheduling.
S38. System according to any one of the preceding system embodiments wherein the controlling component (10) comprises a manager component (10b) that is configured for communication with the mobile components (20).
S39. System according to any one of the preceding system embodiments wherein the controlling component (10) comprises a manager component (10) that is configured for communication with the mobile components (20) via an interface.
S40. System according to any one of the preceding system embodiments wherein the system is configured to be trained with respect of the time and/or duration of mobile components they need for a section of the infrastructure.

Below, method embodiments will be discussed. These embodiments are abbreviated by the letter “M” followed by a number. Whenever reference is herein made to “method embodiments”, these embodiments are meant.
M1. Method for scheduling intralogistics comprising the following steps:
   i. monitoring mobile components (20) and/or infrastructure; and
   ii. adjusting the scheduling of a plurality of mobile components (20) and/or infrastructure at the same time in case of detecting at least one pre-defined event.
M2. Method for scheduling intralogistics comprising the following steps:
   i. monitoring mobile components (20) and/or infrastructure with a frequency of at least one time a minute (1/min.); and
   ii. adjusting the scheduling of a plurality of mobile components (20) and/or infrastructure in case of detecting at least one pre-defined event.
M3. Method for scheduling intralogistics comprising the following steps:
   i. monitoring mobile components (20) and/or infrastructure; and
   ii. adjusting a scheduling of a plurality of mobile components (20) and/or infrastructure with a frequency of adjusting of at least one time a minute (1/min.).
M4. Method combining at least two of any of the preceding method embodiments.
M5. Method according to any of the preceding method embodiments wherein the infrastructure comprises paths, ways, roads, wired and/or wireless communication systems, nodes, handhelds for operators or users, gates, traffic lights, barriers, doors, nodes, induction loops, production material supply, loading stations, unloading stations, battery chargers, and/or batteries.
M6. Method according to any of the preceding method embodiments wherein the plurality of mobile components (20) are at least 10 mobile components, preferably at least 20 mobile components, more preferably at least 50 mobile components, more preferably at least 100 and most preferably at least 1000 mobile components.
M7. Method according to any of the preceding method embodiments wherein the mobile components comprise vehicles (20).
M8. Method according to any of the preceding method embodiments wherein the method is configured for controlling vehicles (20) in a plant.
M9. Method according to any of the preceding method embodiments wherein the method is configured for controlling vehicles (20) in a manufacturing plant.
M10. Method according to any of the preceding method embodiments wherein the method is configured to receive schedule information of each of a plurality of mobile components (20) with a frequency of at least one time a minute (1/min.).
M11. Method according to any of the preceding method embodiments wherein the method is configured to receive schedule information of each of a plurality of mobile components (20) and/or infrastructure with a frequency of at least once each 60 seconds (1/60 s), preferably at least once each 30 seconds (1/30 s), more preferably at least once each 10 seconds (1/10 s), more preferably at least twice a second (2/s), and most preferably once a second (1/s).
M12. Method according to any of the preceding method embodiments, the controlling component (10) further comprising a computing component that is configured to compute an adjusting of the scheduling of a plurality of mobile components.
M13. Method according to any of the preceding method embodiments, the controlling component (10) further comprising a computing component that is configured to compute an adjusting of the scheduling of a plurality of mobile components by computing a plurality of optional schedules and selecting one.
M14. Method according to any of the preceding method embodiments, the controlling component (10) further comprising a computing component that is configured to compute an adjusting of the scheduling of a plurality of mobile components by computing a plurality of optional schedules and selecting the fastest one.
M15. Method according to any of the preceding method embodiments, the controlling component (10) further comprising a computing component that is configured to compute an adjusting of the scheduling of a plurality of mobile components by computing a plurality of optional schedules in parallel and selecting one.
M16. Method according to any of the preceding method embodiments, the controlling component (10) further comprising a remote computing component that is configured to compute an adjusting of the scheduling of a plurality of mobile components by computing a plurality of optional schedules and selecting one.
M17. Method according to any of the preceding method embodiments, the controlling component (10) further comprising a cloud-based computing component that is configured to compute an adjusting of the scheduling of a plurality of mobile components by a computing of a plurality of optional schedules and selecting one.
M18. Method according to any of the preceding method embodiments, the controlling component (10) further comprising a computing component that is configured to compute an adjusting of the scheduling of a plurality of mobile components by computing a plurality of optional schedules and selecting one and providing the selected schedule for the adjusting of the scheduling or the plurality of mobile components (20) and/or infrastructure.
M19. Method according to any of the preceding method embodiments further comprising the step of computing an adjusting of the scheduling of a plurality of mobile components by computing a plurality of optional schedules in parallel and selecting one.
M20. Method according to any of the two preceding method embodiments further comprising the step of computing an adjusting of scheduling of at least 100, preferably at least 1,000, more preferably at least 100,000 and even more than 1 million computations in 1 second.
M21. Method according to any of the preceding method embodiments wherein frequency of monitoring is at least 1,000 times a minute (1,000/min.), preferably 2,500 times a minute (2,500/min.), more preferably 5,000 times a minute (5,000/min.) and most preferably at least 10,000 times a minute (10,000/min.).
M22. Method according to any of the preceding method embodiments wherein a frequency of controlling the intralogistics amounts to at least once at least 2 times a second (2/s), preferably once a second minute (1/s), more preferably once each 10 seconds (1/10 s)) and most preferably at least once each 30 seconds (1/30 s).
M23. Method according to any of the preceding method embodiments wherein a frequency of receiving status information of the intralogistics amounts to at least 1,000 times a minute (1,000/min.), preferably 2,500 times a minute (2,500/min.), more preferably 5,000 times a minute (5,000/min.) and most preferably at least 10,000 times a minute (10,000/min.).
M24. Method according to any of the preceding embodiments wherein the method is configured to monitor and adjust a fleet with a plurality of vehicles.
M25. Method according to any of the preceding method embodiments wherein the vehicles comprise at least one of fork lifts, battery driven vehicles, transport vehicles, mobile robots, vehicles driven by humans.
M26. Method according to any of the preceding method embodiments wherein the pre-defined event comprises a delay or early arrival of a mobile component (20).
M27. Method according to the preceding method embodiment wherein the method further comprises nodes (12) that are references for locations in a plant and wherein the method is configured to detect in case a vehicle is in the vicinity of and/or passing a respective node (12).
M28. Method according to any of the preceding method embodiments wherein the pre-defined event comprises a maintenance need of the mobile component (20).
M29. Method according to any of the preceding method embodiments wherein the pre-defined event comprises a maintenance need of the mobile component (20), such as a failure of operation, a battery charge, a handling problem with material to be moved, wrong material loaded, improper operation.
M30. Method according to any of the preceding method embodiments wherein the method is configured for taking into account the time for loading a battery of a mobile component (20).
M31. Method according to any one of the preceding method embodiments wherein the controlling component (10) comprises an optimizer component (10a) that is configured for controlling the mobile components (20) and for adjusting their scheduling.
M32. Method according to any one of the preceding method embodiments wherein the controlling component (10) comprises a manager component (10b) that is configured for communication with the mobile components (20).
M33. Method according to any one of the preceding method embodiments wherein the controlling component (10) comprises a manager component (10) that is configured for communication with the mobile components (20) via an interface.
M34. Method according to any one of the preceding method embodiments further with the step of training software with respect of the time and/or duration of mobile components they need for a section of the infrastructure,

Below, use embodiments will be discussed. These embodiments are abbreviated by the letter “U” followed by a number. Whenever reference is herein made to “use embodiments”, these embodiments are meant.
U1. Use of the system according to any of the preceding system embodiments for controlling order scheduling in a manufacturing plant.
U2. Use of the method according to any of the preceding method embodiments for controlling order scheduling in a manufacturing plant.

Below, computer related product embodiments will be discussed. These embodiments are abbreviated by the letter “C” followed by a number. Whenever reference is herein made to “computer related product embodiments”, these embodiments are meant.
C1. A computer related product with a program that is configured for carrying out the method according to any of the preceding method embodiments.
C2. A computer related product with a program that has been trained for carrying out the method according to any of the preceding method embodiments.
C3. A computer related product with a program that is configured to be trained for carrying out the method according to any of the preceding method embodiments.

The present invention will now be described with reference to the accompanying drawings, which illustrate embodiments of the invention. These embodiments should only exemplify, but not limit, the present invention.

### FIGURE DESCRIPTION

FIG. 1 schematically exemplifies a system hardware architecture in accordance with the present invention.

FIG. 2 schematically exemplifies an embodiment for a system and a method in accordance with the present invention.

FIG. 3 schematically exemplifies a potential setup for a system and a method in accordance with the present invention.

### DESCRIPTION OF PREFERRED EMBODIMENTS AS EXEMPLIFIED IN THE FIGURES

It is noted that not all the drawings carry all the reference signs. Instead, in some of the drawings, some of the reference signs have been omitted for sake of brevity and simplicity of illustration. Embodiments of the present invention will now be described with reference to the accompanying drawings.

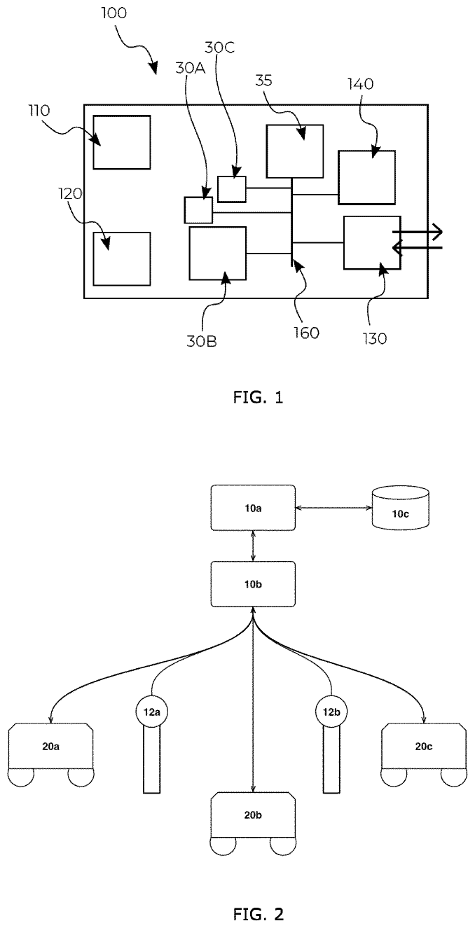

FIG. 1 provides a schematic of a computing device 100. The computing device 100 may comprise a computing unit 35, a first data storage unit 30A, a second data storage unit 30B and a third data storage unit 30C.

The computing device 100 can be a single computing device or an assembly of computing devices. The computing device 100 can be locally arranged or remotely, such as a cloud solution.

On the different data storage units 30 the different data can be stored. Additional data storages can be also provided and/or the ones mentioned before can be combined at least in part.

The computing unit 35 can access the first data storage unit 30A, the second data storage unit 30B and the third data storage unit 30C through the internal communication channel 160, which can comprise a bus connection 160.

The computing unit 30 may be single processor or a plurality of processors, and may be, but not limited to, a CPU (central processing unit), GPU (graphical processing unit), DSP (digital signal processor), APU (accelerator processing unit), ASIC (application-specific integrated circuit), ASIP (application-specific instruction-set processor) or FPGA (field programable gate array). The first data storage unit 30A may be singular or plural, and may be, but not limited to, a volatile or non-volatile memory, such as a random-access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), or Parameter RAM (P-RAM).

The second data storage unit 30B may be singular or plural, and may be, but not limited to, a volatile or non-volatile memory, such as a random-access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), or Parameter RAM (P-RAM). The third data storage unit 30C may be singular or plural, and may be, but not limited to, a volatile or non-volatile memory, such as a random-access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), or Parameter RAM (P-RAM).

It should be understood that generally, the first data storage unit 30A (also referred to as encryption key storage unit 30A), the second data storage unit 30B (also referred to as data share storage unit 30B), and the third data storage unit 30C (also referred to as decryption key storage unit 30C) can also be part of the same memory. That is, only one general data storage unit 30 per device may be provided, which may be configured to store the respective encryption key (such that the section of the data storage unit 30 storing the encryption key may be the encryption key storage unit 30A), the respective data element share (such that the section of the data storage unit 30 storing the data element share may be the data share storage unit 30B), and the respective decryption key (such that the section of the data storage unit 30 storing the decryption key may be the decryption key storage unit 30A).

In some embodiments, the third data storage unit 30C can be a secure memory device 30C, such as, a self-encrypted memory, hardware-based full disk encryption memory and the like which can automatically encrypt all of the stored data. The data can be decrypted from the memory component only upon successful authentication of the party requiring to access the third data storage unit 30C, wherein the party can be a user, computing device, processing unit and the like. In some embodiments, the third data storage unit 30C can only be connected to the computing unit 35 and the computing unit 35 can be configured to never output the data received from the third data storage unit 30C. This can ensure a secure storing and handling of the encryption key (i.e. private key) stored in the third data storage unit 30C.

In some embodiments, the second data storage unit 30B may not be provided but instead the computing device 100 can be configured to receive a corresponding encrypted share from the database 60. In some embodiments, the computing device 100 may comprise the second data storage unit 30B and can be configured to receive a corresponding encrypted share from the database 60.

The computing device 100 may comprise a further memory component 140 which may be singular or plural, and may be, but not limited to, a volatile or non-volatile memory, such as a random access memory (RAM), Dynamic RAM (DRAM), Synchronous Dynamic RAM (SDRAM), static RAM (SRAM), Flash Memory, Magneto-resistive RAM (MRAM), Ferroelectric RAM (F-RAM), or Parameter RAM (P-RAM). The memory component 140 may also be connected with the other components of the computing device 100 (such as the computing component 35) through the internal communication channel 160.

Further the computing device 100 may comprise an external communication component 130. The external communication component 130 can be configured to facilitate sending and/or receiving data to/from an external device (e.g. backup device, recovery device, database). The external communication component 130 may comprise an antenna (e.g. WIFI antenna, NFC antenna, 2G/3G/4G/5G antenna and the like), USB port/plug, LAN port/plug, contact pads offering electrical connectivity and the like. The external communication component 130 can send and/or receive data based on a communication protocol which can comprise instructions for sending and/or receiving data. Said instructions can be stored in the memory component 140 and can be executed by the computing unit 35 and/or external communication component 130. The external communication component 130 can be connected to the internal communication component 160. Thus, data received by the external communication component 130 can be provided to the memory component 140, computing unit 35, first data storage unit 30A and/or second data storage unit 30B and/or third data storage unit 30C. Similarly, data stored on the memory component 140, first data storage unit 30A and/or second data storage unit 30B and/or third data storage unit 30C and/or data generated by the computing unit 35 can be provided to the external communication component 130 for being transmitted to an external device.

In addition, the computing device 100 may comprise an input user interface 110 which can allow the user of the computing device 100 to provide at least one input (e.g. instruction) to the computing device 100. For example, the input user interface 110 may comprise a button, keyboard, trackpad, mouse, touchscreen, joystick and the like.

Additionally, still, the computing device 100 may comprise an output user interface 120 which can allow the computing device 100 to provide indications to the user. For example, the output user interface 110 may be a LED, a display, a speaker and the like.

The output and the input user interface 100 may also be connected through the internal communication component 160 with the internal component of the device 100.

The processor may be singular or plural, and may be, but not limited to, a CPU, GPU, DSP, APU, or FPGA. The memory may be singular or plural, and may be, but not limited to, being volatile or non-volatile, such an SDRAM, DRAM, SRAM, Flash Memory, MRAM, F-RAM, or P-RAM.

The data processing device can comprise means of data processing, such as, processor units, hardware accelerators and/or microcontrollers. The data processing device 20 can comprise memory components, such as, main memory (e.g. RAM), cache memory (e.g. SRAM) and/or secondary memory (e.g. HDD, SDD). The data processing device can comprise busses configured to facilitate data exchange between components of the data processing device, such as, the communication between the memory components and the processing components. The data processing device can comprise network interface cards that can be configured to connect the data processing device to a network, such as, to the Internet. The data processing device can comprise user interfaces, such as:
output user interface, such as:
   screens or monitors configured to display visual data (e.g. displaying graphical user interfaces of the questionnaire to the user),
   speakers configured to communicate audio data (e.g. playing audio data to the user),
input user interface, such as:
   camera configured to capture visual data (e.g. capturing images and/or videos of the user),
   microphone configured to capture audio data (e.g. recording audio from the user),
   keyboard configured to allow the insertion of text and/or other keyboard commands (e.g. allowing the user to enter text data and/or other keyboard commands by having the user type on the keyboard) and/or trackpad, mouse, touchscreen, joystick-configured to facilitate the navigation through different graphical user interfaces of the questionnaire.

The data processing device can be a processing unit configured to carry out instructions of a program. The data processing device can be a system-on-chip comprising processing units, memory components and busses. The data processing device can be a personal computer, a laptop, a pocket computer, a smartphone, a tablet computer. The data processing device can be a server, either local and/or remote. The data processing device can be a processing unit or a system-on-chip that can be interfaced with a personal computer, a laptop, a pocket computer, a smartphone, a tablet computer and/or user interface (such as the upper-mentioned user interfaces).

FIG. 2 exemplifies a system or an arrangement of components in accordance with the present invention. It shows a controlling component 10 that can be composed of an optimizer component 10a, a manager component 10b and a storage 10c. Particularly the latter, but also the other components, can be located remotely, such as in a cloud.

The optimizer component 10a can compute the monitoring and adjusting and/or optimizing of the scheduling. The managing component 10b can be configured to communicate with the mobile components (20), such as vehicles (20), via an interface. This interface can communicate hard-wired and/or wireless with the vehicles (20).

As mentioned before, the vehicles can comprise different kinds, such as robots, lift forks, human-operated vehicles etc. The latter one can be configured to receive instructions from the controlling component 10 on a display, handheld, pc etc. to be considered by the operators.

In the example shown, nodes 12 can be present in any appropriate number. They can be physically arranged and/or of virtual nature. The virtual nature means that they are just hypothetical points or areas in an area where the vehicles 20 move. They are taken to detect the presence and/or timing of a vehicle 20 passing them. In case the time of passing deviates from the expected or pre-calculated time, the optimizer 10a may change the scheduling of one or more vehicles 20 under control.

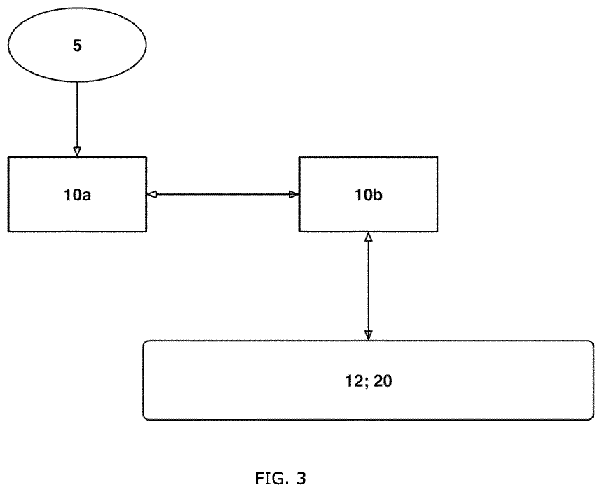

FIG. 3 exemplifies the arrangement and communication between components. There is shown an input 5 that can be configured to feed in one or more order(s). The respective information is communicated to the optimizer component 10a. This optimizer component 10a itself can be configured to plan and/or optimize schedules, such as timed assignments or orders to mobile components, such as transport units. This can be communicated from the optimizer component 10a to the manager component 10b.

The manager component 10b can be configured to generate one or more action command(s) to nodes 12, vehicles 20, mobile robots, manually guided vehicles, humans or better their handheld devices, drones, ships, infrastructure assets (e.g. routing units, doors, signals etc.). The action commands can comprise the commands to drive, pickup, drop-off, open a gate, switch a color, etc.

Those recipients of the commands can then report back their states, events, such as battery status, position, errors, etc.

The manager component 10b can be further configured to feed back the information directly or in processed form to the optimizer component 10a.

Reference numbers and letters appearing between parentheses in the claims, identifying features described in the embodiments and illustrated in the accompanying drawings, are provided as an aid to the reader as an exemplification of the matter claimed. The inclusion of such reference numbers and letters is not to be interpreted as placing any limitations on the scope of the claims.

The term “at least one of a first option and a second option” is intended to mean the first option or the second option or the first option and the second option.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1-18. (canceled)

19. System for controlling intralogistics comprising:
a controlling component
wherein the controlling component is configured for monitoring mobile components and/or infrastructure; and
for adjusting a scheduling of a plurality of mobile components and/or infrastructure at the same time in case of detecting at least one pre-defined event.

20. System according to claim 19, wherein monitoring is carried out at least once a minute.

21. System according to claim 19, wherein scheduling of a plurality of mobile components and/or infrastructure with a frequency of adjusting of at least one time a minute (1/min.) is carried out.

22. System according to claim 19, wherein the controlling component comprises an optimizing component for optimizing the intralogistics and a managing component for communicating with the mobile components and/or the infrastructure.

23. System according to claim 19, wherein the managing component is configured to receive the state of the mobile components and/or the infrastructure, at least in part.

24. System according to claim 19, wherein the managing component is configured to communicate the state of the mobile components and/or the infrastructure, at least in part, to the optimizing component.

25. System according to claim 19, wherein the infrastructure comprises at least one of paths, ways, roads, wired and/or wireless communication systems, handhelds for operators or users, gates, traffic lights, barriers, doors, nodes, induction loops, production material supply, loading stations, unloading stations, battery chargers, and/or batteries.

26. System according to claim 19, wherein the plurality of mobile components and/or infrastructure comprise at least 10 mobile components, preferably at least 20 mobile components, more preferably at least 50 mobile components, more preferably at least 100 mobile components and most preferably at least 1000 mobile components.

27. System according to claim 19, wherein the mobile components comprise vehicles.

28. System according to claim 19, wherein a manager component is configured to generate one or more action command(s) to nodes, vehicles, mobile robots, manually guided vehicles, humans or better their handheld devices, drones, ships, infrastructure assets, such as routing units, doors, signals.

29. System according to claim 19, wherein the system is configured for controlling vehicles and/or infrastructure in a plant.

30. System according to claim 19, wherein the system is configured for controlling vehicles and/or infrastructure in a manufacturing plant.

31. Method for scheduling intralogistics comprising the following steps:
i. monitoring mobile components and/or infrastructure; and
ii. adjusting the scheduling of a plurality of mobile components and/or infrastructure at the same time in case of detecting at least one pre-defined event.

32. Method for scheduling intralogistics according to claim 31, comprising the steps of monitoring mobile components and/or infrastructure with a frequency of at least one time a minute (1/min.).

33. Method for scheduling intralogistics according to claim 31, comprising the step of adjusting a scheduling of a plurality of mobile components and/or infrastructure with a frequency of adjusting of at least one time a minute (1/min.).

34. A computer related product for carrying out the method according to claim 31.
